(19) United States
(12) Patent Application Publication
(10) Pub. No.: US 2026/0205704 A1
(43) Pub. Date: Jul. 16, 2026

(54) ULTRA-SMALL CAMERA ARCHITECTURE BASED ON GENICAM AND WORKING METHOD THEREOF

(71) Applicant: BEIJING BOPIXEL TECHNOLOGY CO., LTD., Beijing (CN)

(72) Inventors: Di WU, Beijing (CN); Jiangbing ZHU, Beijing (CN); Junchao YANG, Beijing (CN); Xilun ZHANG, Beijing (CN)

(21) Appl. No.: 19/270,203

(22) Filed: Jul. 15, 2025

(30) Foreign Application Priority Data
Jan. 10, 2025 (CN) 202510038671.5

(51) Int. Cl. H04N 23/80; H04N 23/50; H04N 23/60; H04N 23/62

(52) U.S. Cl. CPC H04N 23/80; H04N 23/50; H04N 23/62; H04N 23/665

(57) ABSTRACT

Provided are an ultra-small camera architecture based on a GenICam and a working method thereof, and related to the field of camera architecture technologies. The architecture includes a camera lens, a camera, a coaxial cable, a camera input line, and a camera output line. The camera lens and the camera implement data interaction through the coaxial cable. The camera receives an external trigger condition through the input line, and send an encapsulated acquired image to a user through the output line. A size problem of the camera is greatly resolved, and adaption to various space limitation scenarios is facilitated. The camera lens and the camera are separated, to ensure high performance and dissipate heat more efficiently. In addition, the camera lens and the camera are independent of each other without mutual effects, providing basis for quick and agile product iteration.

### CROSS REFERENCE TO RELATED APPLICATION

This patent application claims the benefit and priority of Chinese Patent Application No. 202510038671.5, filed with the China National Intellectual Property Administration on Jan. 10, 2025, the disclosure of which is incorporated by reference herein in its entirety as part of the present application.

### TECHNICAL FIELD

The present disclosure relates to the field of camera architecture technologies, and in particular, relates to an ultra-small camera architecture based on a generic interface for cameras (GenICam) and a working method thereof.

### BACKGROUND

Industrial cameras have increasingly growing requirements for a transmission speed and resolution. These requirements for the transmission speed and resolution are closely associated with performance of a contact image sensor (CIS) and a platform. A high-performance CIS and a high-performance platform are significant in size and power consumption. However, real-world application scenarios are complex and diverse. Some application scenarios have requirements for a camera size, and some application scenarios have requirements for camera power consumption. Both the size and the power consumption are strongly associated with the transmission speed and the resolution. Therefore, there is an urgent need to develop a new camera architecture method by those in the art, to overcome a size problem of the high-performance camera. In this way, heat dissipation and performance can be ensured while an ultra-compact size is ensured, to adapt to an application scenario with a size limitation or a power limitation.

### SUMMARY

The present disclosure provides an ultra-small camera architecture based on a generic Interface for cameras (GenICam), including a camera lens (1), a camera (2), a coaxial cable (3), a camera input line (4), and a camera output line (5), where the camera lens (1) and the camera (2) are configured to implement data interaction through the coaxial cable (3), and the camera (2) is configured to: receive an external trigger condition through the input line (4), and send an encapsulated acquired image to a user through the output line (5); an image sensor (11) and a serializer (12) are disposed inside the camera lens (1), and a data processing and protocol encapsulation platform (21) and a deserializer (22) are disposed inside the camera (2); the image sensor (11) is configured to: perform primary serialization on the acquired image to output serial data and transmit the serial data to the serializer (12); the serializer (12) is configured to: perform secondary serialization on the received serial data, and transmit data obtained after the secondary serialization to the deserializer (22) through the coaxial cable (3); the deserializer (22) is configured to: deserialize the data obtained after the secondary serialization and transmit deserialized data to the data processing and protocol encapsulation platform (21); and the data processing and protocol encapsulation platform (21) is configured to complete further processing and encapsulation of the deserialized data.

According to the ultra-small camera architecture based on a GenICam, a configuration bus (31) is separately disposed between the image sensor (11) and the serializer (12), and between the data processing and protocol encapsulation platform (21) and the deserializer (22); and the data processing and protocol encapsulation platform (21) is configured to transmit configuration information through the configuration bus (31), where the configuration information is forwarded by the deserializer (22) and the serializer (12) to reach the image sensor (11), to implement initial configuration of the image sensor (11).

According to the ultra-small camera architecture based on a GenICam, an image deserialization module (211), an image parsing module (212), an image processing module (213), and an image encapsulation module (214) are further disposed in the data processing and protocol encapsulation platform (21); the data processing and protocol encapsulation platform (21) is configured to: receive data deserialized by the deserializer (22), namely, the serial data output by the image sensor (11), then deserialize the received serial data through the image deserialization module (211), parse the deserialized data through the image parsing module (212) to restore a raw acquired image, perform image enhancement on the acquired image through the image processing module (213) to enhance image quality, and finally perform protocol encapsulation on the acquired image through the image encapsulation module (214), thereby completing data encapsulation at a protocol layer and a link layer for all machine version industrial standard protocols.

According to the ultra-small camera architecture based on a GenICam, a signal processing module (215) and a sensor control module (216) are further disposed in the data processing and protocol encapsulation platform (21), and the signal processing module (215) is configured to emit an external trigger signal according to the external trigger condition received by the input line (4), supporting a smart network file cache (SFNC) function supported by the GenICam; and the sensor control module (216) is configured to generate a control signal of the image sensor (11) according to the external trigger signal.

According to the ultra-small camera architecture based on a GenICam according, a control bus (32) is disposed between the sensor control module (216) and the image sensor (11); and the control signal generated by the sensor control module (216) is transmitted to the image sensor (11) through the control bus (32), to complete real-time control on the image sensor (11).

The present disclosure further provides a working method of an ultra-small camera architecture based on a GenICam, including the following steps:
step 1, sending, by a data processing and protocol encapsulation platform, configuration information to a deserializer through a configuration bus;
step 2, receiving, by a serializer, the configuration information on the deserializer through a coaxial cable, and completing initial configuration of the image sensor through the configuration bus after parsing the configuration information;
step 3, performing, by the image sensor whose initial configuration is completed, image acquisition according to a control signal received from a control bus, performing primary serialization on an acquired image, and then transmitting the acquired image obtained after the primary serialization to the serializer for secondary serialization;
step 4, transmitting data obtained after the secondary serialization to the deserializer through the coaxial cable for deserialization, and further processing the deserialized data through the data processing and protocol encapsulation platform; and
step 5, sending data processed by the data processing and protocol encapsulation platform to a user through an output line.

The present disclosure has the following beneficial effects: A size problem of the camera is greatly resolved, and adaption to various space limitation scenarios is facilitated. The camera lens and the camera are separated, to ensure high performance and dissipate heat more efficiently. In addition, the camera lens and the camera are independent of each other without mutual effects, providing basis for quick and agile product iteration. One camera may be provided with a plurality of camera lens, effectively reducing costs. Due to extremely-strong third-party compatibility adaptation, data encapsulation at a protocol layer and a link layer for all machine version industrial standard protocols can be completed.

### BRIEF DESCRIPTION OF THE DRAWINGS

To describe the technical solutions in embodiments of the present disclosure or the conventional technology more clearly, the following briefly describes the accompanying drawings required for describing the embodiments or the conventional technology. Apparently, the accompanying drawings in the following description show merely some embodiments of the present disclosure, and persons of ordinary skill in the art may still derive other accompanying drawings from these accompanying drawings.

FIG. 1 is a schematic diagram of an architecture of an ultra-small camera architecture based on a generic interface for cameras (GenICam) according to Embodiment 1 of this application; and

FIG. 2 is a schematic flowchart of a working method of an ultra-small camera architecture based on a GenICam according to Embodiment 2 of this application.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

### Embodiment 1

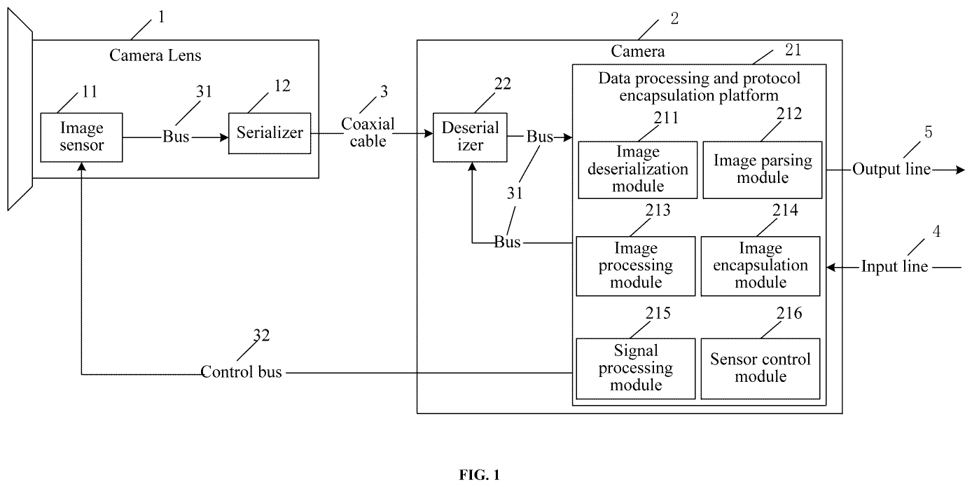

As shown in FIG. 1, Embodiment 1 of this application provides an ultra-small camera architecture based on a generic interface for cameras (GenICam), including a camera lens 1, a camera 2, a coaxial cable 3, a camera input line 4, and a camera output line 5. The camera lens 1 and the camera 2 are configured to implement data interaction through the coaxial cable 3. The camera 2 is configured to: receive an external trigger condition through the input line 4, and send an encapsulated captured image to a user through the output line 5. An image sensor 11 and a serializer 12 are disposed inside the camera lens 1, and a data processing and protocol encapsulation platform 21 and a deserializer 22 are disposed inside the camera 2. The image sensor 11 is configured to: perform primary serialization on the acquired image to output serial data and transmit the serial data to the serializer 12. The serializer 12 is configured to: perform secondary serialization on the received serial data, and transmit data obtained after the secondary serialization to the deserializer 22 through the coaxial cable 3. The deserializer 22 is configured to: deserialize the data obtained after the secondary serialization and transmit deserialized data to the data processing and protocol encapsulation platform 21. The data processing and protocol encapsulation platform 21 is configured to complete further processing and encapsulation of the deserialized data.

The camera lens 1 and the camera 2 are independent of each other, and the camera lens 1 and the camera 2 communicate with each other through the coaxial cable. The camera lens 1 is mainly responsible for image acquisition. The camera 2 is responsible for performing configuration and control on the camera lens, and performing deserialization and encapsulation on acquired data.

A configuration bus 31 is separately disposed between the image sensor 11 and the serializer 12, and between the data processing and protocol encapsulation platform 21 and the deserializer 22. The data processing and protocol encapsulation platform 21 is configured to transmit configuration information through the configuration bus 31, where the configuration information is forwarded by the deserializer 22 and the serializer 12 to reach the image sensor 11, to implement initial configuration of the image sensor 11. An image deserialization module 211, an image parsing module 212, an image processing module 213, an image encapsulation module 214, a signal processing module 215, and a sensor control module 216 are further disposed in the data processing and protocol encapsulation platform 21. The data processing and protocol encapsulation platform 21 is configured to: receive data deserialized by the deserializer 22, namely, the serial data output by the image sensor 11, then deserialize the received serial data through the image deserialization module 211, parse the deserialized data through the image parsing module 212 to restore a raw acquired image, perform image enhancement on the acquired image through the image processing module 213 to enhance image quality, and finally perform protocol encapsulation on the acquired image through the image encapsulation module 214, thereby completing data encapsulation at a protocol layer and a link layer for all machine version industrial standard protocols. A signal processing module 215 is configured to emit an external trigger signal according to the external trigger condition received by the input line 4, supporting a smart network file cache (SFNC) function supported by the GenICam. A sensor control module 216 is configured to generate a control signal of the image sensor 11 according to the external trigger signal. The generated control signal is transmitted to the image sensor 11 through the control bus 32, completing real-time control on the image sensor 11.

The architecture provided in this embodiment of this application has good replacement adaptability to the image sensor 11 and the data processing and protocol encapsulation platform 21. A part of a design of the camera lens 1 only needs to be changed to replace the image sensor 11, and a part of a design of the camera 2 only needs to be changed to replace the data processing and protocol encapsulation platform 21 (to ensure a high speed and a low latency, the data processing and protocol encapsulation platform 21 is generally implemented by a field programmable gate array (FPGA), and to ensure extensibility of the architecture, the data processing and protocol encapsulation platform 21 may alternatively be replaced with an application-specific integrated circuit (AISC) or another high-speed processing platform). The two parts are independent of each other without mutual effects, thereby providing basis for quick and agile product iteration and also effectively reducing the costs. The coaxial cable 3 adopts a gigabit multimedia serial links (GMSL) protocol.

To ensure third-party compatibility adaptation of the camera, the architecture provided in this embodiment of this application can complete data encapsulation at a protocol layer and a link layer for all machine version industrial standard protocols, including: GigE Vision, Camera Link, Camera Link High Speed, CoaXPress, USB3 Vision, and Custom Transport Layer.

### Embodiment 2

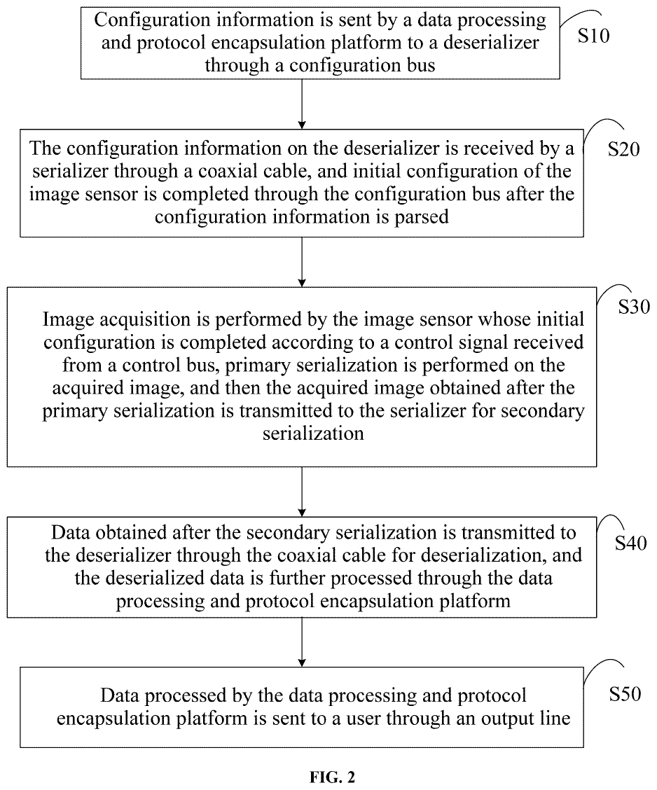

As shown in FIG. 2, Embodiment 2 of this application provides a working method of an ultra-small camera architecture based on a GenICam, including the following steps.

In step S10, configuration information is sent by a data processing and protocol encapsulation platform to a deserializer through a configuration bus.

An image sensor supports a plurality of working modes. Each working mode is pre-configured with corresponding configuration information, and the configuration information is stored in the data processing and protocol encapsulation platform. After a user selects a working mode, corresponding configuration information is sent to the image sensor, to complete an initial configuration operation by the image sensor. However, due to particularity of the architecture of the camera in this embodiment (that is, the camera lens and the camera are independent of each other), configuration information cannot be directly sent by the data processing and protocol encapsulation platform in the camera to the image sensor inside the camera lens. Therefore, the configuration information needs to be firstly sent to the deserializer with a connection relationship to the camera lens through a configuration bus, and then the configuration information is forwarded to the camera lens through the deserializer.

In step S20, the configuration information on the deserializer is received by a serializer through a coaxial cable, and initial configuration of the image sensor is completed through the configuration bus after the configuration information is parsed.

The serializer is directly connected to the deserializer through the coaxial cable, to implement data interaction between the camera lens and the camera. After receiving the configuration information on the deserializer through the coaxial cable, the serializer further needs to parse the configuration information into a configuration command of the image sensor. The configuration command is transmitted through the configuration bus between the serializer and the image sensor, to complete initial configuration of the image sensor. The configuration information is parsed by using a mapping table, and configuration commands corresponding to all configuration items are stored in the mapping table. The configuration commands corresponding to the configuration items included in the configuration information are obtained by the serializer from the mapping table through query, and the configuration commands are completed according to values of the configuration items. For example, if there is a configuration item “resolution” with a value of “800×600” in the configuration information, a corresponding configuration command in the mapping table is as follows:

“Router (config)#screen-length?; Router (config)#screen-width?”, where ? is a placeholder, configured to fill a value of the configuration item, and two values on the left and right of the symbol are respectively filled to locations of the two ?, to obtain a complete configuration command:

“Router (config)#screen-length 800; Router (config)#screen-width 600”. In this case, parsing work of the configuration item “resolution” is completed.

In step S30, image acquisition is performed by the image sensor whose initial configuration is completed according to a control signal received from a control bus, primary serialization is performed on the acquired image, and then the acquired image obtained after the primary serialization is transmitted to the serializer for secondary serialization.

The control bus is a group of self-defined control lines based on the image sensor, and is configured to implement control on the image controller, including a control signal with high real-time performance such as exposure control, and read-out control. An image acquisition procedure based on the control bus specifically includes the following sub steps.

In step S31, an external trigger condition on an input line is read by a signal processing module, and an external trigger signal is emitted according to the external trigger condition.

The external trigger condition is a technical means taken by the user to acquire a required image, and is defined based on the SFNC function supported by the GenICam, including delayed capture, multi-shot capture, external exposure control, encoder trigging, and the like. The module may emit a corresponding external trigger signal when the external trigger condition is met, to implement automatic image acquisition. The delayed capture is used as an example. A single shot is taken by the user every two seconds. In this case, an external trigger signal for a one-shot action should be emitted by the signal processing module every two seconds.

In step S32, the control signal is transmitted by a sensor control module, according to the control signal generated by the external trigger signal emitted by the signal processing module, to the image sensor through the control bus.

Different kinds of external trigger signals are associated with corresponding control signals. These control signals are transmitted to the image sensor through the bus for directly controlling the image sensor to make a corresponding action. It should be noted that, in the ultra-small camera architecture based on a GenICam, a plurality of camera lenses may be disposed, and correspondingly, there may be a plurality of image sensors inside the camera lenses. The control signal is transmitted by each image sensor through one independent control bus, and each control bus supports only unidirectional transmission.

In step S33, the image acquisition is performed by the image sensor according to the received control signal, and the primary serialization is performed on the acquired image to output serial data.

When a pixel is directly output by the image sensor, a plurality of pixels may be output once to increase a transmission speed, and consequently, subsequent image recovery difficulty is increased. Therefore, primary serialization needs to be performed on the acquired image before the output, to form a data sequence, thereby ensuring orderliness of image pixel transmission.

In step S34, the secondary serialization is performed by the serializer on the serial data output by the image sensor.

The secondary serialization has two effects: adapting to long-distance transmission and unifying formats of data output by different image images. The secondary serialization procedure may be understood as follows: A data sequence X⁽⁰⁾ output by the image sensor is compressed into a byte stream X⁽¹⁾ in a unified manner. The byte stream X⁽¹⁾ is written into a transmission file. A mathematical expression of a data compression algorithm is:

$${X}^{( 1 )} = {⋃}_{i = 1}^{N} ( \sqrt{\frac{2}{N}} {C}_{i} {x}_{i}^{( 0 )} \times cos ( \frac{π}{N} ( i + \frac{1}{2} ) i ) ) ,$$

where X⁽¹⁾ is a compressed byte stream sequence,

$${x}_{i}^{( 0 )}$$

is the i^{th} data in the raw data sequence X⁽⁰⁾, Cᵢ is a conversion coefficient of

$${x}_{i}^{( 0 )} ,$$

i ranges from 1 to N, and N is a length of the raw data sequence X⁽⁰⁾.

In step S40, data obtained after the secondary serialization is transmitted to the deserializer through the coaxial cable for deserialization, and the deserialized data is further processed through the data processing and protocol encapsulation platform.

The deserializer is configured to perform deserialization on the data obtained after the secondary serialization, in other words, the byte stream X⁽¹⁾ in the transmission file is restored to the data sequence X⁽⁰⁾ output by the image sensor by using an inverse compression algorithm. A mathematical expression of the inverse compression algorithm

$${X}^{( 0 )} = {⋃}_{j = 1}^{M} ( \sqrt{\frac{2}{M}} {C}_{j} {x}_{j}^{( 1 )} \times cos ( \frac{π}{M} ( j + \frac{1}{2} ) j ) ) ,$$

where X⁽⁰⁾ is the raw data sequence obtained after decompression,

$${x}_{j}^{( 1 )}$$

is a j^{th} byte in the byte stream sequence X⁽¹⁾, Cⱼ is a conversion coefficient of

$${x}_{j}^{( 1 )} ,$$

j ranges from 1 to M, and M is a length of the byte stream sequence X⁽¹⁾.

The data sequence X⁽⁰⁾ obtained by deserializing via the deserializer is transmitted to the data processing and protocol encapsulation platform for performing image restoration, processing, and encapsulation. Details are as follows.

In step S41, data returned by the deserializer is restored by an image deserialization module to an image pixel.

The image deserialization module is configured to perform deserialization for primary serialization of the acquired image. To be specific, the serial data output by the image sensor is restored to image pixels that are orderly arranged. There are a plurality of serialization and deserialization methods for image data, and therefore, the user can invoke the methods according to needs. Details are not described herein again.

In step S42, the image pixel is restored by an image parsing module to a complete acquired image.

The restored acquired image is identified with a camera lens serial number and an acquisition timestamp, to facilitate distinguishing and quick locating.

In step S43, image enhancement is performed by the image processing module on the acquired image.

An unprocessed raw image is directly obtained from the image sensor, and the image further needs to be enhanced before being encapsulated, including but not limited to: white balance, black level, noise reduction, contrast, cropping, binning, sharpening, and the like. Therefore, the user can increase or decrease processing steps in the module according to needs.

In step S44, protocol encapsulation is performed by an image encapsulation module on the enhanced acquired image.

This module can complete data encapsulation at a protocol layer and a link layer for all machine version industrial standard protocols, including: GigE Vision, Camera Link, Camera Link High Speed, CoaXPress, USB3 Vision, and Custom Transport Layer.

In step S50, data processed by the data processing and protocol encapsulation platform is sent to a user through an output line.

The data processed by the data processing and protocol encapsulation platform is actually an encapsulated message. The encapsulated message further needs to be added with check code at the end before being sent. Integrity of the message is checked by a receive end according to the check code. To improve sensitivity of the check code, a calculation formula of the check code is further combined with a specific random correlation, and is

$$S = {\sum }_{k = 1}^{w - max ( {δ}_{1} , {δ}_{2} , {δ}_{3} )} [ \frac{1}{w - max ( {δ}_{1} , {δ}_{2} , {δ}_{3} )} \times ( {B}_{k} \times {B}_{k + {δ}_{1}} + {B}_{k + {δ}_{2}} ) \% {2}^{{B}_{k + {δ}_{3}}} ] ,$$

where S is a calculation result of the check code, Bₖ, B_{k+δ}_{₁}, B_{k+δ}_{₂}, and B_{k+δ}_{₂} are respectively decimal values converted from the k^{th}, k+δ₁^{th}, k+δ₂^{th}, and k+δ₃^{th} bytes in message data. δ₁, δ₂, and δ₃ are three random numbers, k ranges from 1 to w-max (δ₁, δ₂, δ₃), and w is a total length of the message.

The three random numbers δ₁, δ₂, and δ₃ are added to the head of the message. After the user receives the message, the check code is calculated again by using the same calculation formula. If the calculation result is consistent with the check code on the tail of the message, it indicates that the message is complete. If the calculation result is inconsistent with the check code, it indicates that the message is incomplete, and a message needs to be re-obtained.

Corresponding to the foregoing embodiments, an embodiment of the present disclosure provides a non-transitory computer storage medium, including at least one memory and at least one processor.

The memory is configured to store one or more program instructions.

The processor is configured to run the one or more program instructions, to execute a working method of an ultra-small camera architecture based on a GenICam according.

Corresponding to the foregoing embodiment, an embodiment of the present disclosure provides a computer-readable storage medium. The computer-readable storage medium includes one or more program instructions. The one or more program instructions are used to enable a processor to perform a working method of an ultra-small camera architecture based on a GenICam.

An embodiment of the present disclosure further provides a computer-readable storage medium. The computer-readable storage medium stores computer instructions. When the computer instructions are run on a computer, the computer is enabled to perform a working method of an ultra-small camera architecture based on a GenICam.

In this embodiment of the present disclosure, the processor may be an integrated circuit capable of signal processing. The processor may be a general-purpose processor, a digital signal processor (DSP), an application-specific integrated circuit (ASIC), a field programmable gate array (FPGA) or another programmable logic device, a discrete gate or transistor logic device, or a discrete hardware component.

The processor can implement or execute the methods, steps and logical block diagrams disclosed in the embodiments of the present disclosure. The general-purpose processor may be a microprocessor, or the processor may be any conventional processor or the like. The steps of the methods disclosed in the embodiments of the present disclosure may be directly executed by a hardware decoding processor, or executed by a combination of hardware and software modules in the decoding processor. The software module may be located in a mature storage medium in the art, such as a random access memory a flash memory, a read-only memory, a programmable read-only memory, an electrically erasable programmable memory, or a register. The processor reads information in the memory, and completes the operations of the foregoing methods in combination with hardware in the processor.

The storage medium may be a memory, for example, may be a volatile memory or a non-volatile memory, or may include both a volatile memory and a non-volatile memory.

The non-volatile memory may be a read-only memory (ROM), a programmable ROM (PROM), an erasable PROM (EPROM), an electrically EPROM (EEPROM), or a flash memory.

The volatile memory may be a random access memory (RAM), used as an external cache. Through illustrative rather than restrictive description, RAMs of many forms are available, for example, a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DRRAM).

The storage medium described in the embodiments of the present disclosure is intended to include, but not be limited to, these and any other suitable types of memory.

A person skilled in the art should be aware that in the foregoing one or more examples, the functions described in the present disclosure may be implemented by combination of hardware and software. When implemented by software, the functions may be stored in a computer-readable medium or transmitted as one or more instructions or code on the computer-readable medium. The computer-readable medium includes a computer storage medium and a communication medium, where the communication medium includes any medium that facilitates transfer of a computer program from one place to another. The storage medium may be any usable medium accessible by a general-purpose computer or a special-purpose computer. The objectives, technical solutions, and beneficial effects of the present disclosure are further described in detail in the foregoing specific implementations. It should be understood that the foregoing descriptions are merely specific implementations of the present disclosure, but are not intended to limit the protection scope of the present disclosure. Any modification, equivalent replacement, or improvement made based on technical solutions of the present disclosure shall fall within the protection scope of the present disclosure.

What is claimed is:

1. An ultra-small camera architecture based on a generic interface for cameras (GenICam), comprising:
a camera lens, a camera, a coaxial cable, a camera input line, and a camera output line, wherein the camera lens and the camera are configured to implement data interaction through the coaxial cable, and the camera is configured to:
receive an external trigger condition through the input line, and
send an encapsulated acquired image to a user through the output line;
an image sensor and a serializer are disposed inside the camera lens, and a data processing and protocol encapsulation platform and a deserializer are disposed inside the camera;
the image sensor is configured to: perform primary serialization on the acquired image to output serial data and transmit the serial data to the serializer;
the serializer is configured to: perform secondary serialization on the received serial data, and transmit data obtained after the secondary serialization to the deserializer through the coaxial cable;
the deserializer is configured to: deserialize the data obtained after the secondary serialization and transmit deserialized data to the data processing and protocol encapsulation platform; and
the data processing and protocol encapsulation platform is configured to complete further processing and encapsulation of the deserialized data.

2. The ultra-small camera architecture based on a GenICam according to claim 1, wherein a configuration bus is separately disposed between the image sensor and the serializer, and between the data processing and protocol encapsulation platform and the deserializer; and the data processing and protocol encapsulation platform is configured to transmit configuration information through the configuration bus, wherein the configuration information is forwarded by the deserializer and the serializer to reach the image sensor to implement initial configuration of the image sensor.

3. The ultra-small camera architecture based on a GenICam according to claim 1, wherein an image deserialization module, an image parsing module, an image processing module, and an image encapsulation module are further disposed in the data processing and protocol encapsulation platform; the data processing and protocol encapsulation platform is configured to: receive data deserialized by the deserializer, namely, the serial data output by the image sensor, then deserialize the received serial data through the image deserialization module, parse the deserialized data through the image parsing module to restore a raw acquired image, perform image enhancement on the acquired image through the image processing module to enhance image quality, and finally perform protocol encapsulation on the acquired image through the image encapsulation module, wherein the image encapsulation module is able to perform data encapsulation at a protocol layer and a link layer for all machine version industrial standard protocols.

4. The ultra-small camera architecture based on a GenICam according to claim 1, wherein a signal processing module and a sensor control module are further disposed in the data processing and protocol encapsulation platform, and the signal processing module is configured to emit an external trigger signal according to the external trigger condition received by the input line; and the sensor control module is configured to generate a control signal of the image sensor according to the external trigger signal.

5. The ultra-small camera architecture based on a GenICam according to claim 4, wherein a control bus is disposed between the sensor control module and the image sensor; and the control signal generated by the sensor control module is transmitted to the image sensor through the control bus, to complete real-time control on the image sensor.

6. A working method of an ultra-small camera architecture based on a GenICam, applied to the ultra-small camera architecture based on a GenICam according to claim 1, comprising:
step 1, sending, by the data processing and protocol encapsulation platform, configuration information to the deserializer through the configuration bus;
step 2, receiving, by the serializer, the configuration information on the deserializer through the coaxial cable, and completing initial configuration of the image sensor through the configuration bus after parsing the configuration information;
step 3, performing, by the image sensor whose initial configuration is completed, image acquisition according to the control signal received from the control bus, performing primary serialization on an acquired image, and then transmitting the acquired image obtained after the primary serialization to the serializer for secondary serialization;
step 4, transmitting data obtained after the secondary serialization to the deserializer through the coaxial cable for deserialization, and further processing the deserialized data through the data processing and protocol encapsulation platform; and
step 5, sending data processed by the data processing and protocol encapsulation platform to a user through the output line.

7. The working method of an ultra-small camera architecture based on a GenICam according to claim 6, wherein the performing, by the image sensor whose initial configuration is completed, image acquisition according to the control signal received from the control bus, performing primary serialization on an acquired image, and then transmitting the acquired image obtained after the primary serialization to the serializer for secondary serialization specifically comprises the following sub steps:
reading, by the signal processing module, the external trigger condition on the input line, and emitting the external trigger signal according to the external trigger condition;
transmitting, by the sensor control module according to the control signal generated by the external trigger signal emitted by the signal processing module, the control signal to the image sensor through the control bus;
performing, by the image sensor according to the received control signal, the image acquisition, and performing the primary serialization on the acquired image to output serial data; and
performing, by the serializer, the secondary serialization on the serial data output by the image sensor.

8. The working method of an ultra-small camera architecture based on a GenICam according to claim 6, wherein the further processing the deserialized data through the data processing and protocol encapsulation platform specifically comprises the following sub steps:
restoring, by the image deserialization module, data returned by the deserializer to an image pixel;
restoring, by the image parsing module, the image pixel to a complete acquired image;
performing, by the image processing module, image enhancement on the acquired image; and
performing, by the image encapsulation module, protocol encapsulation on the enhanced acquired image.

9. A non-transitory computer storage medium, comprising at least one memory and at least one processor, wherein
the memory is configured to store one or more program instructions; and
the processor is configured to run the one or more program instructions, to execute the working method of an ultra-small camera architecture based on a GenICam according to claim 6.

10. The working method of an ultra-small camera architecture based on a GenICam according to claim 6, wherein a configuration bus is separately disposed between the image sensor and the serializer, and between the data processing and protocol encapsulation platform and the deserializer; and the data processing and protocol encapsulation platform is configured to transmit configuration information through the configuration bus, wherein the configuration information is forwarded by the deserializer and the serializer to reach the image sensor, to implement initial configuration of the image sensor.

11. The working method of an ultra-small camera architecture based on a GenICam according to claim 6, wherein an image deserialization module, an image parsing module, an image processing module, and an image encapsulation module are further disposed in the data processing and protocol encapsulation platform; the data processing and protocol encapsulation platform is configured to: receive data deserialized by the deserializer, namely, the serial data output by the image sensor, then deserialize the received serial data through the image deserialization module, parse the deserialized data through the image parsing module to restore a raw acquired image, perform image enhancement on the acquired image through the image processing module to enhance image quality, and finally perform protocol encapsulation on the acquired image through the image encapsulation module, wherein the image encapsulation module is able to perform data encapsulation at a protocol layer and a link layer for all machine version industrial standard protocols.

12. The working method of an ultra-small camera architecture based on a GenICam according to claim 6, wherein a signal processing module and a sensor control module are further disposed in the data processing and protocol encapsulation platform, and the signal processing module is configured to emit an external trigger signal according to the external trigger condition received by the input line; and the sensor control module is configured to generate a control signal of the image sensor according to the external trigger signal.

13. The working method of an ultra-small camera architecture based on a GenICam according to claim 12, wherein a control bus is disposed between the sensor control module and the image sensor; and the control signal generated by the sensor control module is transmitted to the image sensor through the control bus, to complete real-time control on the image sensor.

14. A non-transitory computer storage medium, comprising at least one memory and at least one processor, wherein
the memory is configured to store one or more program instructions; and
the processor is configured to run the one or more program instructions, to execute the working method of an ultra-small camera architecture based on a GenICam according to claim 7.

15. A non-transitory computer storage medium, comprising at least one memory and at least one processor, wherein
the memory is configured to store one or more program instructions; and
the processor is configured to run the one or more program instructions, to execute the working method of an ultra-small camera architecture based on a GenICam according to claim 8.
